(19) United States
(12) Patent Application Publication
(10) Pub. No.: US 2025/0272925 A1
(43) Pub. Date: Aug. 28, 2025

(54) IMAGE PROCESSING METHOD, APPARATUS, AND STORAGE MEDIUM

(71) Applicant: Beijing Zitiao Network Technology Co., Ltd., Beijing (CN)

(72) Inventors: Xiaoxing CHEN, Beijing (CN); JIACHENG LIU, Beijing (CN)

(21) Appl. No.: 18/730,740

(22) PCT Filed: Jan. 12, 2023
(86) PCT No.: PCT/CN2023/071878

§ 371 Date: Jul. 19, 2024

(30) Foreign Application Priority Data
Jan. 21, 2022 (CN) 202210072428.1

(51) Int. Cl. G06T 19/00; G06T 15/20

(52) U.S. Cl. CPC G06T 19/006; G06T 15/20

(57) ABSTRACT

The embodiments of the present disclosure provide an image processing method, apparatus, device and a storage medium. The method includes: obtaining a target object detected in a current key frame and a rendered virtual object corresponding to the current key frame, wherein the key frame is a frame which triggers object detection; determining, based on the detected target object and a vision space queue, a virtual object to be newly added; determining, based on the rendered virtual object and the vision space queue, a virtual object to be deleted; and updating, based on the virtual object to be newly added and the virtual object to be deleted, a virtual object corresponding to the current key frame.

The present disclosure claims the priority to the CN patent application Ser. No. 20/220,072428.1 filed in the China National Intellectual Property Administration on Jan. 21, 2022, the contents of which are hereby incorporated by reference in their entirety.

### FIELD

Embodiments of the present disclosure generally relate to the field of augmented reality technologies, and more specifically, to an image processing method, apparatus, device and storage medium.

### BACKGROUND

It is a common application scenario in augmented reality that virtual objects are mounted on detected object objects. In such application scenario, it is required to perform target detection in the space. Typically, overlapping determination and deletion of target objects out of the view are required after detecting the same target object in the space multiple times. In the related technologies, filtering duplicate objects and deletion of objects out of the view are implemented probably by target tracking and feature matching, but this approach is bulky in computing amount and less efficient.

### SUMMARY

Embodiments of the present disclosure provide an image processing method and apparatus, device and storage medium, which can reduce the computing amount when updating virtual objects, thereby improving the image processing efficiency.

In a first aspect, embodiments of the present disclosure provide an image processing method, comprising:

obtaining a target object detected in a current key frame and a rendered virtual object corresponding to the current key frame, wherein the key frame is a frame which triggers object detection;

determining, based on the detected target object and a vision space queue, a virtual object to be newly added, wherein the vision space queue comprises visions spaces corresponding to N key frames closest to a current moment, and the current key frame is an N^{th} key frame in the vision space queue;

determining, based on the rendered virtual object and the vision space queue, a virtual object to be deleted; and

updating, based on the virtual object to be newly added and the virtual object to be deleted, a virtual object corresponding to the current key frame.

In a second aspect, the embodiments of the present disclosure provide an image processing apparatus, comprising:

a target object detection module configured to obtain a target object detected in a current key frame and a rendered virtual object corresponding to the current key frame, wherein the key frame is a frame which triggers object detection;

a virtual object to be newly added determining module configured to determine, based on the detected target object and a vision space queue, a virtual object to be newly added, wherein the vision space queue comprises visions spaces corresponding to N key frames closest to a current moment, and the current key frame is an N^{th} key frame in the vision space queue;

a virtual object to be deleted determining module configured to determine, based on the rendered virtual object and the vision space queue, a virtual object to be deleted; and

a virtual object updating module configured to update, based on the virtual object to be newly added and the virtual object to be deleted, a virtual object corresponding to the current key frame.

In a third aspect, the embodiments of the present disclosure further provide an electronic device, comprising:

at least one processor;

a memory configured to store at least one computer program;

wherein the at least one computer program, when executed by the at least one processor, causes the at least one processor to implement the image processing method as described in the embodiments of the present disclosure.

In a fourth aspect, the embodiments of the present disclosure also provide a computer readable medium having computer programs stored thereon, wherein the computer programs, when executed by a processor, implement the method as described in the embodiments of the present disclosure.

### BRIEF DESCRIPTION OF THE DRAWINGS

FIG. 1 illustrates a flowchart of an image processing method according to an embodiment of the present disclosure;

FIG. 2 illustrates a schematic diagram of a view frustum according to an embodiment of the present disclosure;

FIG. 3 illustrates an example diagram of a target object newly added in the current key frame according to an embodiment of the present disclosure;

FIG. 4 illustrates a structural schematic diagram of an image processing apparatus according to an embodiment of the present disclosure; and

FIG. 5 illustrates a structural schematic diagram of an electronic device according to an embodiment of the present disclosure.

### DETAILED DESCRIPTION OF EMBODIMENTS

Reference now will be made to the drawings to describe in detail the embodiments of the present disclosure.

It would be appreciated that respective steps in the implementations of the method according to the present disclosure may be performed in different orders and/or performed in parallel. In addition, the method implementations may include additional steps and/or steps omitted. The scope of the present disclosure is not limited thereto.

As used herein, the term “includes” and its variants are to be read as open-ended terms that mean “includes, but is not limited to.” The term “based on” is to be read as “based at least in part on.” The term “an embodiment” is to be read as “at least one embodiment;” the term “another embodiment” is to be read as “at least one further embodiment;” the term “some examples” is to be read as “at least some examples.” Related definitions of other terms will be provided in the description below.

It should be noted that, the terms “first,” “second” and the like mentioned in the present disclosure are only used to distinguish different apparatuses, modules or units, rather than limit an order of functions performed by the apparatus, module or unit or limit interdependence.

It should be noted that, the terms “one” and “a plurality of” mentioned in the present disclosure are illustrative, not restrictive, and should be understood as “at least one” by those skilled in the art, unless explicitly specified otherwise in the context.

Names of messages or information interacted between a plurality of apparatuses in the embodiments of the present disclosure are illustrative rather than limit the scope of the message or information.

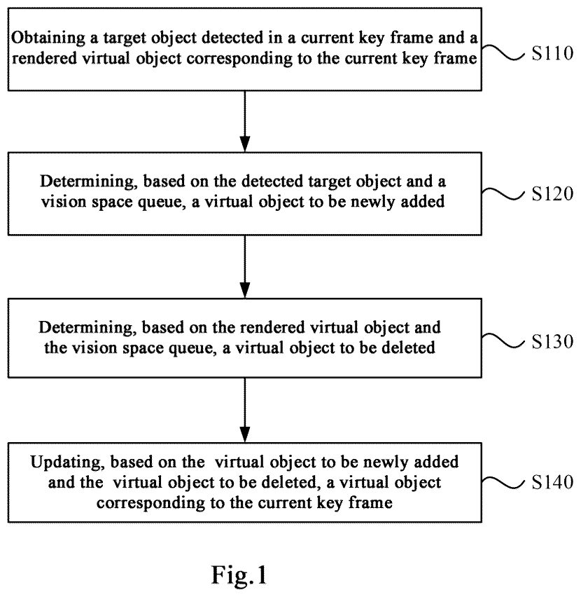

FIG. 1 illustrates a flowchart of an image processing method according to an embodiment of the present disclosure. The embodiment can be applied to update a virtual object in an image for a three-dimensional space. The method can be executed by an image processing apparatus. The apparatus may include hardware and/or software and can be typically integrated in a device with an image processing function, which may be an electronic device such as a server, a mobile terminal, a server cluster or the like. As shown in FIG. 1, the method includes steps of:

S110, obtaining a target object detected in a current key frame and a rendered virtual object corresponding to the current key frame.

Wherein, the key frame is a frame which triggers object detection, and when meeting a preset trigger condition, the terminal device triggers an object detection module to detect the target object in the current image. The preset trigger condition may be: every preset number of video frames or a number of currently rendered virtual objects in every preset duration is less than a preset value, or the like. In the embodiment, the target object detection algorithm according to the related technology may be employed to detect the target object in the current image, which is not limited here.

The rendered virtual object may be read as a virtual object displayed and mounted on an object in the three-dimensional space, which is a 3D object. The virtual object may be of any theme category, for example, the “Lantern Festival” theme, where the virtual object may be virtual lantern, virtual sweet dumpling and the like, which is not limited here.

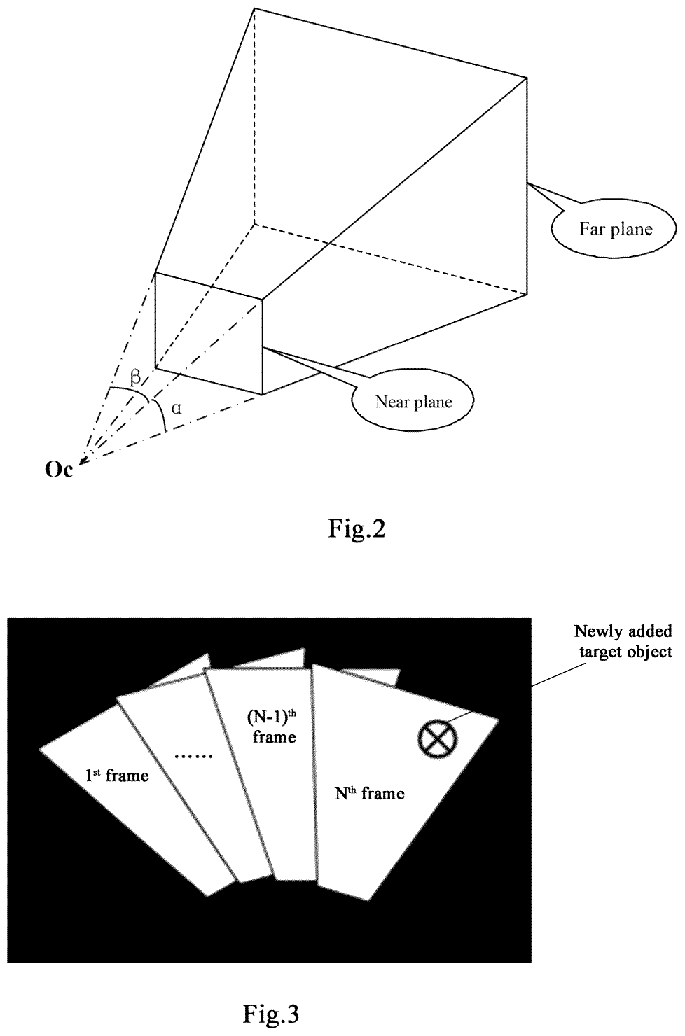

S120: determining, based on the detected target object and a vision space queue, a virtual object to be newly added.

Wherein, the vision space queue includes visions spaces corresponding to N key frames closest to a current moment, and the current key frame is the N^{th} key frame in the vision space queue. In the case, the previous key frame is the (N−1)^{th} key frame, and the like. The vision space may be read as a visible area on the screen in the three-dimensional world, i.e., a capturable range of a virtual camera. The vision space is a three-dimensional space falling in a camera-capturing range, with a camera-capturing angle being a viewing angle. Alternatively, the vision space is characterized by a view frustum that is enclosed by a plurality of boundary surfaces. In the present embodiment, the view frustum is enclosed by 6 boundary surfaces, namely a near plane, a far plane and four side surfaces. By way of example, FIG. 2 illustrates a schematic diagram of the view frustum according to this embodiment, where Oc represents a camera. A set of terrace spaces formed by the view frustum i is called Qi. For the vision space queue, a set of areas formed by vision spaces corresponding to the N key frames is represented as: Q=Q₁∪Q₂∪ . . . ∪Q_{N}, which is specifically represented as p∈Q if the three-dimensional space point p is located in the space Q. Due to the memory limitation of the computing unit and the increment as time elapses, the reference significance of the information of the old key frames is reduced for the new key frames, and the old key frames therefore can be deleted at a proper time. Accordingly, visions spaces corresponding to N key frames closest to the current moment are preserved in the vision space queue.

The virtual object to be newly added is determined depending on the newly-added target object in the current key frame. If a target object is newly added to the current key frame, it is required to mount a new virtual object on the newly-added target object. By way of example, determining, based on the detected target object and the vision space queue, the virtual object to be newly added may include: determining, based on the detected target object and the vision space queue, a newly added target object; and determining, based on the newly added target object, the virtual object to be newly added.

The newly added target object may be read as a target object newly detected in the current frame, i.e., an object not detected in the previous key frames. Determining, based on the newly added target object, the virtual object to be newly added may include: determining a virtual object block based on a detection block of the newly added target object, obtaining a corresponding material in the virtual object, and adding the material into the virtual object block and rendering the same, to obtain the newly added target.

In the embodiment, determining, based on the detected target object and the vision space queue, the newly added target object comprises: determining whether the detected target object falls in at least one of a 1^{st} to an (N−1)^{th} vision space in the vision space queue; and in response to the detected target object falling out of the at least one of the 1^{st} to the (N−1)^{th} vision space in the vision space queue, determining that the detected target object is the newly added target object; and in response to the target object detected falling in the at least one of the 1^{st} to the (N−1)^{th} vision space in the vision space queue, determining that the detected object is an old target object.

For example, if the detected target object falls out of the 1^{st} to the (N−1)^{th} vision space in the vision space queue, the detected target object is a newly added target object. Assumed that the target object is characterized by the center point p of the target object, if p∉Q₁∪Q₂∪ . . . ∪Q_{N-1}, it is indicated that the detected target object is a newly added target object. By way of example, FIG. 3 illustrates an example diagram of the newly added target object in the current key frame according to this embodiment. As shown therein, if not falling in any one of the 1^{st} to the (N−1)^{th} vision space, the detected target object is a newly added target object.

Alternatively, determining whether the detected target object falls in the at least one of the 1^{st} to the (N−1)^{th} vision space in the vision space queue may include: for each vision space in the 1^{st} to the (N−1)^{th} vision space, projecting the vision space to a camera plane, to obtain a two-dimensional area corresponding to the vision space; projecting a three-dimensional center point of the detected target object to the camera plane, to obtain a two-dimensional center point; determining whether the two-dimensional center point falls in the two-dimensional area; and in response to the two-dimensional center point falling in the two-dimensional area, determining that the detected target object falls in the vision space.

In the embodiment, according to the projection principle, the vision space may be projected to a camera plane, and a three-dimensional center point of the detected target object may be projected to the camera plane. Determining whether the two-dimensional center point falls in the two-dimensional area may include determining whether coordinates of the two-dimensional center point meet a function set corresponding to the two-dimensional area, where, in response to the two-dimensional center point meeting the function set corresponding to the two-dimensional area, the two-dimensional center point is within the two-dimensional area. If the two-dimensional center point is within the two-dimensional area, it is indicated that the three-dimensional center point of the target object is in the view frustum, and at this time, the detected target object falls in the vision space. By characterizing the target object with a three-dimensional center point, the computing amount can be greatly reduced.

Alternatively, determining whether the detected target object falls in at least one of the 1^{st} to the (N−1)^{th} vision space in the vision space queue may include: for each vision space in the 1^{st} to the (N−1)^{th} vision space, obtaining a polygonal pyramid including a plurality of boundary surfaces, where the polygonal pyramid corresponds to the vision space corresponding to a three-dimensional center point of the detected target object respectively; computing a volume sum of a plurality of polygonal pyramids; and in response to the volume sum being equal to a volume of a view frustum corresponding to the vision space, determining that the target detected object falls in the vision space.

In this embodiment, the view frustum corresponding to the vision space is enclosed by 6 boundary surfaces, where each surface includes four sides. In the case, the three-dimensional center point, together with each boundary surface, forms a quadrangular pyramid, and 6 quadrangular pyramids are obtained accordingly. A volume of each quadrangular pyramid is computed, and volumes of the 6 quadrangular pyramids are summed up. If the volume sum is equal to the volume of the view frustum, it is indicated that the three-dimensional center point of the target object is in the view frustum, and at this time, the detected target object falls in the vision space.

S130, determining, based on the rendered virtual object and the vision space queue, a virtual object to be deleted.

In this embodiment, if the rendered virtual object has not been detected for a period of time, the rendered virtual object needs to be deleted, to save the resources and the memory space.

By way of example, determining, based on the rendered virtual object and the vision space queue, the virtual object to be deleted may include: determining whether the rendered virtual object falls in a most recently set number of vision spaces in the vision space queue; and in response to the rendered virtual object falling out of the most recently set number of vision spaces in the vision space queue, determining that the rendered virtual object is the virtual object to be deleted.

Wherein, the set number is less than or equal to N, which may be, for example, N/2. By way of example, assumed that N is 10, the set number may be 5. In the embodiment, if the rendered virtual object falls out of the most recently set number of vision spaces, the rendered virtual object is a virtual object to be deleted. It would be appreciated that the most recently set number of vision spaces in the vision space queue are vision spaces, in the vision space queue, corresponding to the set number of the key frames closest to the current moment.

Alternatively, determining whether the rendered virtual object falls in the most recently set number of vision spaces in the vision space queue may include: for each vision space in the most recently set number of vision spaces in the vision space queue, projecting the vision space to the camera plane, to obtain a two-dimensional area corresponding to the vision space; projecting a three-dimensional center point of the rendered virtual object to the camera plane, to obtain a two-dimensional center point; determining whether the two-dimensional center point is within the two-dimensional area; and in response to the two-dimensional center point being within the two-dimensional area, determining that the rendered virtual object falls in the vision space.

In this embodiment, according to the projection principle, the vision space may be projected to a camera plane, and a three-dimensional center point of the rendered virtual object may be projected to the camera plane. Determining whether the two-dimensional center point falls in the two-dimensional area may include determining whether coordinates of the two-dimensional center point meet a function set corresponding to the two-dimensional area, where, if yes, the two-dimensional center point is within the two-dimensional area. If the two-dimensional center point is within the two-dimensional area, it is indicated that the three-dimensional center point of the rendered virtual object is in the view frustum, and at this time, the detected rendered virtual object falls in the vision space. By characterizing the rendered virtual object with a three-dimensional center point, the computing amount can be greatly reduced.

Alternatively, determining whether the rendered virtual object falls in the most recently set number of vision spaces in the vision space queue may include: for each vision space in the most recently set number of vision spaces in the vision space queue, obtaining a polygonal pyramid including a plurality of boundary surfaces, where the polygonal pyramid corresponds to the vision space corresponding to a three-dimensional center point of the rendered virtual respectively; computing a volume sum of a plurality of polygonal pyramids; and in response to the volume sum being equal to a volume of a view frustum corresponding to the vision space, determining that the rendered virtual object falls in the vision space.

In this embodiment, the view frustum corresponding to the vision space is enclosed by 6 boundary surfaces, where each surface includes four sides. In the case, the three-dimensional center point, together with each boundary surface, forms a quadrangular pyramid, and 6 quadrangular pyramids are obtained accordingly. A volume of each quadrangular pyramid is computed, and volumes of the 6 quadrangular pyramids are summed up. If the volume sum is equal to the volume of the view frustum, it is indicated that the three-dimensional center point of the target object is in the view frustum, and at this time, the detected target object falls in the vision space.

S140, updating, based on the virtual object to be newly added and the virtual object to be deleted, a virtual object corresponding to the current key frame.

By way of example, updating, based on the virtual object to be newly added and the virtual object to be deleted, the virtual object corresponding to the current key frame may include: mounting the virtual object to be newly added on a position corresponding to the newly added target object, and deleting the virtual object to be deleted.

In the current key frame, a set of rendered virtual objects after a virtual object is newly added is Pₖ=Pₖ₋₁∪(Q̅₁̅∪̅Q̅₂̅∪̅ .̅ .̅ .̅ ∪̅Q̅_̅{̅N̅-̅1̅}̅∩Dₖ), where Pₖ represents the rendered virtual object corresponding to the current frame after updating, Dₖ represents the newly mounted virtual object, and Pₖ₋₁ represents the rendered virtual object corresponding to the current frame before updating.

In the current key frame, a set of the rendered virtual objects after the virtual object is deleted is Pₖ=Pₖ₋₁∩(Q₁∪Q₂∪ . . . ∪Q_{N}), where Pₖ represents the rendered virtual object corresponding to the key frame after updating, and Pₖ₋₁ represents the rendered virtual object corresponding to the current key frame before updating.

The technical solution according to the embodiments of the present disclosure include: obtaining a target object detected in a current key frame and a rendered virtual object corresponding to the current key frame, wherein the key frame is a frame which triggers object detection; determining, based on the detected target object and a vision space queue, a virtual object to be newly added, wherein the vision space queue comprises visions spaces corresponding to N key frames closest to a current moment, and the current key frame is an N^{th} key frame in the vision space queue; determining, based on the rendered virtual object and the vision space queue, a virtual object to be deleted; and updating, based on the virtual object to be newly added and the virtual object to be deleted, a virtual object corresponding to the current key frame. By determining, based on the detected target object and a vision space queue, a virtual object to be newly added, and determining, based on the rendered virtual object and the vision space queue, a virtual object to be deleted, the image processing method according to the embodiments of the present disclosure can reduce the computing amount when updating virtual objects, thus improving the image processing efficiency.

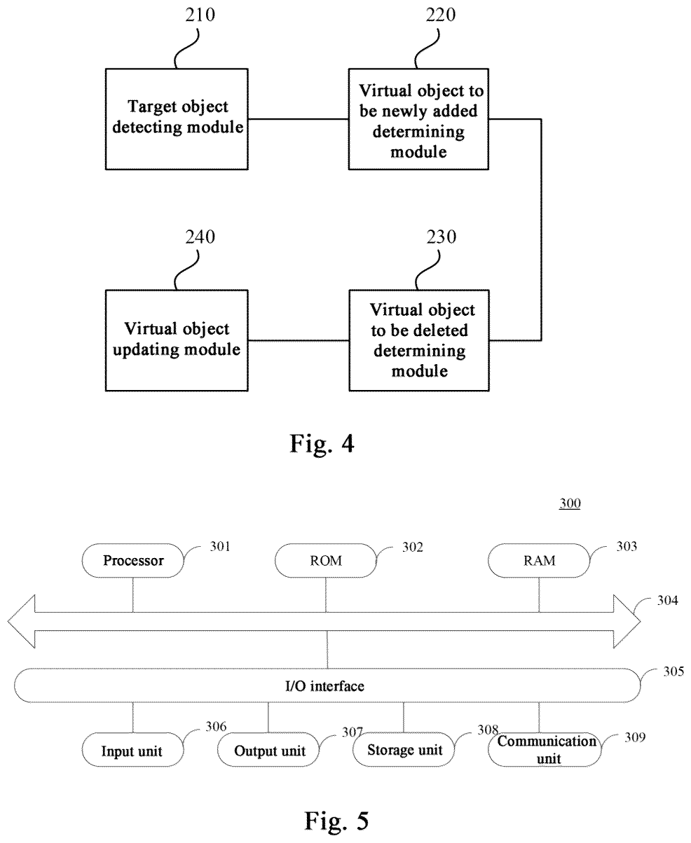

FIG. 4 is a structural schematic diagram of an image processing apparatus according to embodiments of the present disclosure. As shown therein, the apparatus includes:

a target object detection module 210 configured to obtain a target object detected in a current key frame and a rendered virtual object corresponding to the current key frame, wherein the key frame is a frame which triggers object detection;

a virtual object to be newly added determining module 220 configured to determine, based on the detected target object and a vision space queue, a virtual object to be newly added, wherein the vision space queue comprises visions spaces corresponding to N key frames closest to a current moment, and the current key frame is an N^{th} key frame in the vision space queue;

a virtual object to be deleted determining module 230 configured to determine, based on the rendered virtual object and the vision space queue, a virtual object to be deleted; and

a virtual object updating module 240 configured to update, based on the virtual object to be newly added and the virtual object to be deleted, a virtual object corresponding to the current key frame.

Alternatively, the virtual object to be newly added determining module 220 is further configured to:

determine, based on the detected target object and the vision space queue, a newly added target object; and

determine, based on the newly added target object, the virtual object to be newly added.

Alternatively, the virtual object updating module 240 is further configured to:

mount the virtual object to be newly added to a position corresponding to the newly added target object.

Alternatively, the virtual object to be newly added determining module 220 is further configured to:

determine whether the detected target object falls in at least one of a 1^{st} to an (N−1)^{th} vision space in the vision space queue; and

in response to the detected target object falling out of the at least one of the 1^{st} to the (N−1)^{th} vision space in the vision space queue, determine that the detected target object is the newly added target object; and in response to the target object detected falling in the at least one of the 1^{st} to the (N−1)^{th} vision space in the vision space queue, determine that the detected object is an old target object.

Alternatively, the virtual object to be deleted determining module 230 is further configured to:

determine whether the rendered virtual object falls in a most recently set number of vision spaces in the vision space queue; and

in response to the rendered virtual object falling out of the most recently set number of vision spaces in the vision space queue, determine that the rendered virtual object is the virtual object to be deleted, wherein the most recently set number is less than or equal to N.

Alternatively, the vision space is characterized by a view frustum that is enclosed by a plurality of boundary surfaces.

Alternatively, the virtual object to be newly added determining module 220 is further configured to:

for each vision space in the 1^{st} to the (N−1)^{th} vision space, project the vision space to a camera plane, to obtain a two-dimensional area corresponding to the vision space;

project a three-dimensional center point of the detected target object to the camera plane, to obtain a two-dimensional center point;

determine whether the two-dimensional center point falls in the two-dimensional area; and

in response to the two-dimensional center point falling in the two-dimensional area, determine that the detected target object falls in the vision space.

Alternatively, the virtual object to be newly added determining module 220 is further configured to:

for each vision space in the 1^{st} to the (N−1)^{th} vision space, obtain a polygonal pyramid comprising a plurality of boundary surfaces, wherein the polygonal pyramid corresponds to the vision space corresponding to a three-dimensional center point of the detected target object respectively;

compute a volume sum of a plurality of polygonal pyramids; and

in response to the volume sum being equal to a volume of a view frustum corresponding to the vision space, determine that the target detected object falls in the vision space.

Alternatively, the virtual object to be deleted determining module 230 is further configured to:

for each vision space in the most recently set number of vision spaces in the vision space queue, project the vision space to a camera plane, to obtain a two-dimensional area corresponding to the vision space;

project a three-dimensional center point of the rendered virtual object to the camera plane, to obtain a two-dimensional center point;

determine whether the two-dimensional center point is within the two-dimensional area; and

in response to the two-dimensional center point being within the two-dimensional area, determine that the rendered virtual object falls in the vision space.

Alternatively, the virtual object to be deleted determining module 230 is further configured to:

for each vision space in the most recently set number of vision spaces in the vision space queue, obtain a polygonal pyramid comprising a plurality of boundary surfaces, wherein the polygonal pyramid corresponds to the vision space corresponding to a three-dimensional center point of the rendered virtual respectively;

compute a volume sum of a plurality of polygonal pyramids; and

in response to the volume sum being equal to a volume of a view frustum corresponding to the vision space, determine that the rendered virtual object falls in the vision space.

The apparatus can perform the method provided by all the above-mentioned embodiments of the present disclosure, which includes corresponding functional modules for performing the above method. For the technical details not exhausted here, see those of the method provided by all the above-mentioned embodiments of the present disclosure.

Reference below will be made to FIG. 5 which illustrates a structural schematic diagram of an electronic device 300 adapted to implement embodiments of the present disclosure. The electronic device according to the embodiments of the present disclosure may include, but is not limited to, a mobile terminal such as a mobile phone, a laptop computer, a digital broadcast receiver, a Personal Digital Assistant (PDA), a Portable Android Device (PAD), a Portable Media Player (PMP), an on-vehicle terminal (e.g. an on-vehicle navigation terminal) or the like, or a fixed terminal such as a digital TV, a desktop computer or the like. The electronic device as shown in FIG. 5 is provided merely as an example, without suggesting any limitation to the functions and the application range of the embodiments of the present disclosure.

As shown therein, the electronic device 300 may include a processor (e.g. a central processor, a graphics processor or the like) 301, which can execute various acts and processing based on programs stored in a Read Only Memory (ROM) 302 or a program loaded from a memory 305 to a Random Access Memory (RAM) 303. RAM 303 stores therein various programs and data required for operations of the electronic device 300. The processor 301, the ROM 902 and the RAM 303 are connected to one another via a bus 304. An input/output (I/O) interface 305 is also connected to the bus 304.

Typically, the following units may be connected to the I/O interface 305: input unit 306 including, for example, a touchscreen, a touch pad, a keyboard, a mouse, a camera, a microphone, an accelerometer, a gyroscope and the like; output unit 307 including, for example, a Liquid Crystal Display (LCD), a loudspeaker, a vibrator and the like; storage unit 308 including, for example, a tape, a hard drive and the like; and communication unit 309. The communication unit 309 can allow wireless or wired communication of the electronic device 300 with other devices to exchange data. Although FIG. 5 shows the electronic device 300 including various units, it would be appreciated that not all of the units as shown are required to be implemented or provided. Alternatively, more or fewer units may be implemented or provided.

In particular, according to embodiments of the present disclosure, the processes described above with reference to the flowcharts may be implemented as computer software programs. For example, embodiments of the present disclosure include a computer program product comprising a computer program carried on a computer readable medium, the computer program containing program code for performing the image processing method according to the present disclosure. In those embodiments, the computer program may be downloaded and installed from a network via the communication unit 309, or may be installed from the memory 305, or may be installed from the ROM 302. The computer program, when executed by the processor 301, performs the above-described functions defined in the method according to the embodiments of the present disclosure.

It should be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to: obtaining a target object detected in a current key frame and a rendered virtual object corresponding to the current key frame, wherein the key frame is a frame which triggers object detection; determining, based on the detected target object and a vision space queue, a virtual object to be newly added, wherein the vision space queue comprises visions spaces corresponding to N key frames closest to a current moment, and the current key frame is an N^{th} key frame in the vision space queue; determining, based on the rendered virtual object and the vision space queue, a virtual object to be deleted; and updating, based on the virtual object to be newly added and the virtual object to be deleted, a virtual object corresponding to the current key frame.

Computer program codes for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program codes may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowchart and block diagrams in the drawings illustrate the functionality and operation of possible implementations of methods, apparatus and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

The units described in the embodiments of the present disclosure may be implemented by software or hardware. Wherein, the designation of a module or unit does not in some cases constitute a limitation of the unit itself. For example, the first obtaining unit may also be described as “a unit for obtaining at least two Internet Protocol addresses.”

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to at least one of embodiments of the present disclosure, there is provided an image processing method, comprising:

obtaining a target object detected in a current key frame and a rendered virtual object corresponding to the current key frame, wherein the key frame is a frame which triggers object detection;

determining, based on the detected target object and a vision space queue, a virtual

object to be newly added, wherein the vision space queue comprises visions spaces corresponding to N key frames closest to a current moment, and the current key frame is an N^{th} key frame in the vision space queue;

determining, based on the rendered virtual object and the vision space queue, a virtual object to be deleted; and

updating, based on the virtual object to be newly added and the virtual object to be deleted, a virtual object corresponding to the current key frame.

Alternatively, determining, based on the detected target object and the vision space queue, the virtual object to be newly added comprises:

determining, based on the detected target object and the vision space queue, a newly added target object; and

determining, based on the newly added target object, the virtual object to be newly added; and

updating, based on the virtual object to be newly added, the virtual object corresponding to the current key frame comprises:

rendering the virtual object to be newly added to a position corresponding to the newly added target object.

Alternatively, determining, based on the detected target object and the vision space queue, the newly added target object comprises:

determining whether the detected target object falls in at least one of a 1^{st} to an (N−1)^{th} vision space in the vision space queue; and

in response to the detected target object falling out of the at least one of the 1^{st} to the (N−1)^{th} vision space in the vision space queue, determining that the detected target object is the newly added target object; and in response to the target object detected falling in the at least one of the 1st to the (N-1)^{th} vision space in the vision space queue, determining that the detected object is an old target object.

Alternatively, determining, based on the rendered virtual object and the vision space queue, the virtual object to be deleted comprises:

determining whether the rendered virtual object falls in a most recently set number of vision spaces in the vision space queue; and

in response to the rendered virtual object falling out of the most recently set number of vision spaces in the vision space queue, determining that the rendered virtual object is the virtual object to be deleted, wherein the most recently set number is less than or equal to N.

Alternatively, the vision space is characterized by a view frustum that is enclosed by a plurality of boundary surfaces.

Alternatively, determining whether the detected target object falls in the at least one of the 1^{st} to the (N−1)^{th} vision space in the vision space queue comprises:

for each vision space in the 1^{st} to the (N−1)^{th} vision space, projecting the vision space to a camera plane, to obtain a two-dimensional area corresponding to the vision space;

projecting a three-dimensional center point of the detected target object to the camera plane, to obtain a two-dimensional center point;

determining whether the two-dimensional center point falls in the two-dimensional area; and

in response to the two-dimensional center point falling in the two-dimensional area, determining that the detected target object falls in the vision space.

Alternatively, determining whether the detected target object falls in at least one of the 1^{st} to the (N−1)^{th} vision space in the vision space queue comprises:

for each vision space in the 1^{st} to the (N−1)^{th} vision space, obtaining a polygonal pyramid comprising a plurality of boundary surfaces, wherein the polygonal pyramid corresponds to the vision space corresponding to a three-dimensional center point of the detected target object respectively;

computing a volume sum of a plurality of polygonal pyramids; and

in response to the volume sum being equal to a volume of a view frustum corresponding to the vision space, determining that the target detected object falls in the vision space.

Alternatively, determining whether the rendered virtual object falls in the most recently set number of vision spaces in the vision space queue comprises:

for each vision space in the most recently set number of vision spaces in the vision space queue, projecting the vision space to a camera plane, to obtain a two-dimensional area corresponding to the vision space;

projecting a three-dimensional center point of the rendered virtual object to the camera plane, to obtain a two-dimensional center point;

determining whether the two-dimensional center point is within the two-dimensional area; and

in response to the two-dimensional center point being within the two-dimensional area, determining that the rendered virtual object falls in the vision space.

Alternatively, determining whether the rendered virtual object falls in the most recently set number of vision spaces in the vision space queue comprises:

for each vision space in the most recently set number of vision spaces in the vision space queue, obtaining a polygonal pyramid comprising a plurality of boundary surfaces, wherein the polygonal pyramid corresponds to the vision space corresponding to a three-dimensional center point of the rendered virtual respectively;

computing a volume sum of a plurality of polygonal pyramids; and

in response to the volume sum being equal to a volume of a view frustum corresponding to the vision space, determining that the rendered virtual object falls in the vision space.

1. A method of image processing, comprising:
obtaining a target object detected in a current key frame and a rendered virtual object corresponding to the current key frame, wherein the key frame is a frame which triggers object detection;
determining, based on the detected target object and a vision space queue, a virtual object to be newly added, wherein the vision space queue comprises visions spaces corresponding to N key frames closest to a current moment, and the current key frame is an N^{th} key frame in the vision space queue;
determining, based on the rendered virtual object and the vision space queue, a virtual object to be deleted; and
updating, based on the virtual object to be newly added and the virtual object to be deleted, a virtual object corresponding to the current key frame.

2. The method of claim 1, wherein determining, based on the detected target object and the vision space queue, the virtual object to be newly added comprises:
determining, based on the target object detected and the vision space queue, a newly added target object; and
determining, based on the newly added target object, the virtual object to be newly added; and
updating, based on the virtual object to be newly added, the virtual object corresponding to the current key frame comprises:
rendering the virtual object to be newly added to a position corresponding to the newly added target object.

3. The method of claim 2, wherein determining, based on the detected target object and the vision space queue, the newly added target object comprises:
determining whether the detected target object falls in at least one of a 1^{st} to an (N−1)^{th} vision space in the vision space queue; and
in response to the detected target object falling out of the at least one of the 1^{st} to the (N−1)^{th} vision space in the vision space queue, determining that the detected target object is the newly added target object; and in response to the target object detected falling in the at least one of the 1^{st} to the (N-1)^{th} vision space in the vision space queue, determining that the detected object is an old target object.

4. The method of claim 1, wherein determining, based on the rendered virtual object and the vision space queue, the virtual object to be deleted comprises:
determining whether the rendered virtual object falls in a most recently set number of vision spaces in the vision space queue; and
in response to the rendered virtual object falling out of the most recently set number of vision spaces in the vision space queue, determining that the rendered virtual object is the virtual object to be deleted, wherein the most recently set number is less than or equal to N.

5. The method of claim 4, wherein the vision space is a three-dimensional space falling in a camera-capturing range, and with a camera-capturing angle being a viewing angle; and wherein the vision space is characterized by a view frustum that is enclosed by a plurality of boundary surfaces.

6. The method of claim 5, wherein determining whether the detected target object falls in the at least one of the 1^{st} to the (N-1)^{th} vision space in the vision space queue comprises:
for each vision space in the 1^{st} to the (N-1)^{th} vision space, projecting the vision space to a camera plane, to obtain a two-dimensional area corresponding to the vision space;
projecting a three-dimensional center point of the detected target object to the camera plane, to obtain a two-dimensional center point;
determining whether the two-dimensional center point falls in the two-dimensional area; and
in response to the two-dimensional center point falling in the two-dimensional area, determining that the detected target object falls in the vision space.

7. The method of claim 5, wherein determining whether the detected target object falls in at least one of the 1^{st} to the (N−1)^{th} vision space in the vision space queue comprises:
for each vision space in the 1^{st} to the (N−1)^{th} vision space, obtaining a polygonal pyramid comprising a plurality of boundary surfaces, wherein the polygonal pyramid corresponds to the vision space corresponding to a three-dimensional center point of the detected target object respectively;
computing a volume sum of a plurality of polygonal pyramids; and
in response to the volume sum being equal to a volume of a view frustum corresponding to the vision space, determining that the target detected object falls in the vision space.

8. The method of claim 5, wherein determining whether the rendered virtual object falls in the most recently set number of vision spaces in the vision space queue comprises:
for each vision space in the most recently set number of vision spaces in the vision space queue, projecting the vision space to a camera plane, to obtain a two-dimensional area corresponding to the vision space;
projecting a three-dimensional center point of the rendered virtual object to the camera plane, to obtain a two-dimensional center point;
determining whether the two-dimensional center point is within the two-dimensional area; and
in response to the two-dimensional center point being within the two-dimensional area, determining that the rendered virtual object falls in the vision space.

9. The method of claim 5, wherein determining whether the rendered virtual object falls in the most recently set number of vision spaces in the vision space queue comprises:
for each vision space in the most recently set number of vision spaces in the vision space queue, obtaining a polygonal pyramid comprising a plurality of boundary surfaces, wherein the polygonal pyramid corresponds to the vision space corresponding to a three-dimensional center point of the rendered virtual respectively;
computing a volume sum of a plurality of polygonal pyramids; and
in response to the volume sum being equal to a volume of a view frustum corresponding to the vision space, determining that the rendered virtual object falls in the vision space.

10. (canceled)

11. (Current Amended) An electronic device, comprising:
at least one processor;
a memory configured to store at least one computer program;
wherein the at least one computer program, when executed by the at least one processor, causes the at least one processor to implement actions comprising:
obtaining a target object detected in a current key frame and a rendered virtual object corresponding to the current key frame, wherein the key frame is a frame which triggers object detection;
determining, based on the detected target object and a vision space queue, a virtual object to be newly added, wherein the vision space queue comprises visions spaces corresponding to N key frames closest to a current moment, and the current key frame is an N^{th} key frame in the vision space queue;
determining, based on the rendered virtual object and the vision space queue, a virtual object to be deleted; and
updating, based on the virtual object to be newly added and the virtual object to be deleted, a virtual object corresponding to the current key frame.

12. (Current Amended) A computer readable medium having computer programs stored thereon, wherein the computer programs, when executed by a processor, implement a method of image processing comprising:
obtaining a target object detected in a current key frame and a rendered virtual object corresponding to the current key frame, wherein the key frame is a frame which triggers object detection;
determining, based on the detected target object and a vision space queue, a virtual object to be newly added, wherein the vision space queue comprises visions spaces corresponding to N key frames closest to a current moment, and the current key frame is an N^{th} key frame in the vision space queue;
determining, based on the rendered virtual object and the vision space queue, a virtual object to be deleted; and
updating, based on the virtual object to be newly added and the virtual object to be deleted, a virtual object corresponding to the current key frame.

13. The electronic device of claim 11, wherein determining, based on the detected target object and the vision space queue, the virtual object to be newly added comprises:
determining, based on the target object detected and the vision space queue, a newly added target object; and
determining, based on the newly added target object, the virtual object to be newly added; and
updating, based on the virtual object to be newly added, the virtual object corresponding to the current key frame comprises:
rendering the virtual object to be newly added to a position corresponding to the newly added target object.

14. The electronic device of claim 13, wherein determining, based on the detected target object and the vision space queue, the newly added target object comprises:
determining whether the detected target object falls in at least one of a 1^{st} to an (N−1)^{th} vision space in the vision space queue; and
in response to the detected target object falling out of the at least one of the 1^{st} to the (N−1)^{th} vision space in the vision space queue, determining that the detected target object is the newly added target object; and in response to the target object detected falling in the at least one of the 1^{st} to the (N−1)^{th} vision space in the vision space queue, determining that the detected object is an old target object.

15. The electronic device of claim 11, wherein determining, based on the rendered virtual object and the vision space queue, the virtual object to be deleted comprises:
determining whether the rendered virtual object falls in a most recently set number of vision spaces in the vision space queue; and
in response to the rendered virtual object falling out of the most recently set number of vision spaces in the vision space queue, determining that the rendered virtual object is the virtual object to be deleted, wherein the most recently set number is less than or equal to N.

16. The electronic device of claim 15, wherein the vision space is a three-dimensional space falling in a camera-capturing range, and with a camera-capturing angle being a viewing angle; and wherein the vision space is characterized by a view frustum that is enclosed by a plurality of boundary surfaces.

17. The electronic device of claim 16, wherein determining whether the detected target object falls in the at least one of the 1^{st} to the (N−1)^{th} vision space in the vision space queue comprises:
for each vision space in the 1st to the (N-1)^{th} vision space, projecting the vision space to a camera plane, to obtain a two-dimensional area corresponding to the vision space;
projecting a three-dimensional center point of the detected target object to the camera plane, to obtain a two-dimensional center point;
determining whether the two-dimensional center point falls in the two-dimensional area; and
in response to the two-dimensional center point falling in the two-dimensional area, determining that the detected target object falls in the vision space.

18. The computer readable medium of claim 12, wherein determining, based on the detected target object and the vision space queue, the virtual object to be newly added comprises:
determining, based on the target object detected and the vision space queue, a newly added target object; and
determining, based on the newly added target object, the virtual object to be newly added; and
updating, based on the virtual object to be newly added, the virtual object corresponding to the current key frame comprises:
rendering the virtual object to be newly added to a position corresponding to the newly added target object.

19. The computer readable medium of claim 18, wherein determining, based on the detected target object and the vision space queue, the newly added target object comprises:
determining whether the detected target object falls in at least one of a 1^{st} to an (N−1)^{th} vision space in the vision space queue; and
in response to the detected target object falling out of the at least one of the 1^{st} to the (N−1)^{th} vision space in the vision space queue, determining that the detected target object is the newly added target object; and in response to the target object detected falling in the at least one of the 1^{st} to the (N−1)^{th} vision space in the vision space queue, determining that the detected object is an old target object.

20. The computer readable medium of claim 12, wherein determining, based on the rendered virtual object and the vision space queue, the virtual object to be deleted comprises:
determining whether the rendered virtual object falls in a most recently set number of vision spaces in the vision space queue; and
in response to the rendered virtual object falling out of the most recently set number of vision spaces in the vision space queue, determining that the rendered virtual object is the virtual object to be deleted, wherein the most recently set number is less than or equal to N.

21. The computer readable medium of claim 20, wherein the vision space is a three-dimensional space falling in a camera-capturing range, and with a camera-capturing angle being a viewing angle; and wherein the vision space is characterized by a view frustum that is enclosed by a plurality of boundary surfaces.
